(19) United States
(12) Patent Application Publication
(10) Pub. No.: US 2006/0066459 A1
(43) Pub. Date: Mar. 30, 2006

(54) Multi-view head-up synthetic vision display system

(76) Inventors: Douglas Burch, Center Point, IA (US); Michael Braasch, Athens, OH (US)

Correspondence Address: CALFEE HALTER & GRISWOLD, LLP, 800 SUPERIOR AVENUE, SUITE 1400, CLEVELAND, OH, 44114, US

(21) Appl. No.: 10/530,971

(22) PCT Filed: Oct. 9, 2003
(86) PCT No.: PCT/US03/32306

§ 371 Date: Aug. 11, 2005

Related U.S. Application Data
(60) Provisional application No. 60/417,388, filed on Oct. 9, 2002.

(51) Int. Cl. G01C 21/00

(52) U.S. Cl. 340/980

(57) ABSTRACT

Systems and methods for providing an enhanced head up display to an aircraft pilot are disclosed. According to a first aspect of the present invention, a system for increasing pilot situational awareness is disclosed. The system includes a navigational component that determines one or more of an aircraft location and attitude. The system also includes a scene generator that produces one or more virtual images of the space into which the aircraft is flying based, at least in part, on the aircraft location and/or attitude. The system further includes one or more head up displays that display the one or more virtual images to facilitate increasing pilot situational awareness. Other systems and methods for providing an enhanced head up display are also disclosed.

### CROSS-REFERENCE TO RELATED APPLICATION

This application claims priority to U.S. Provisional Application entitled “Multi-View Head-Up Synthetic Vision Display System,” Ser. No. 60/417,388, filed Oct. 9, 2002, which is incorporated herein by reference in its entirety.

### TECHNICAL FIELD

The systems, methods, and computer readable media described herein relate generally to controllers and more particularly to a multi-resolution controller using wavelets.

### BACKGROUND

Within a range of favorable weather conditions, the Federal Aviation Administration (FAA) rules permit operating an aircraft under Visual Flight Rules (VFR). In less favorable conditions, known as Instrument Meteorological Conditions (IMC), FAA rules require pilots to operate their aircraft utilizing the instruments of the aircraft. Visual flight into instrument meteorological conditions and low-level maneuvering flight have historically been the two areas of flight producing the largest number of fatal accidents. With regard to VFR flight into IMC, it appears that one reason that pilots have trouble is spatial disorientation.

One well publicized aircraft accident stemming from VFR flight into IMC is the 1999 crash of John F. Kennedy, Jr.'s Piper Saratoga into the Atlantic. On July 16^{th}, 1999, at approximately 2038 hrs, John F. Kennedy Jr. departed from Essex County Airport in Fairfield, N.J. in his Piper Saratoga. Conditions were reported as hazy with poor visibility but still within Visual Flight Rules (VFR). At 2130 hrs, roughly one hour into the flight, the Piper Saratoga disappeared from radar. His plane crashed into the Atlantic Ocean off the coast of Massachusetts and Rhode Island killing Mr. Kennedy and his two passengers. It is believed that John F. Kennedy Jr. was suffering from vertigo and was not aware of the aircraft's attitude and therefore was not able to control its flight path correctly. This example illustrates the need for alternative instrumentation to enable a pilot to maintain situational awareness and potentially avert a disaster.

Spatial disorientation arises in conditions that deprive the pilot of natural visual references to maintain orientation, such as clouds, fog, haze, darkness, or terrain/sky backgrounds with indistinct contrast. These conditions occur, for example, during arctic whiteout, clear moonless skies over water, and so on. The body's internal attitude sensors are very accurate if one is experiencing little or no motion if the body is moving at a higher velocity, then visual cues come into play supplying the brain with a sense of spatial orientation. Once a pilot enters clouds, he or she will experience mild to strong impressions of spatial disorientation. A 2001 Nall Report states that because these false impressions are based on physics and a basic aspect of human physiology, they cannot be avoided by training and can, therefore, affect pilots of all experience levels. A study conducted from 1987 to 1996 concluded that one fatal spatial disorientation accident occurred every eleven days over this ten-year period. Spatial disorientation related accidents are a direct result of visual flight into IMC. Visual flight into IMC continues to be one of the leading causes of General Aviation (GA) accidents resulting in fatalities. This brings to light the importance of Synthetic Vision Systems (SVS), for not only commercial aircraft, but for general aviation cockpits as well.

GA as a means of transportation, whether for business or pleasure, can be safe and time efficient given favorable flying conditions. However, when IMC prevails, a pilot navigates and lands an aircraft using conventional instrumentation 100 such as that illustrated in FIG. 1. Such conventional instrumentation 100 has undergone little change in the past fifty years.

Gauges and dials are used to determine the spatial orientation of the aircraft rather than the intuitive “out the window view” used during Visual Meteorological Conditions (VMC). Out the window views include front views, such as looking out over the nose of the plane, and side views, such as looking out the side window. Being based on visual feedback from the world in which the plane is flying, such as an actual horizon and an actual runway location, VMC flight has proven safer than IMC flight, where the feedback is instrument related, relying on an artificial horizon and artificial symbology for navigation locations. Thus, VMC flight is safer for low-time instrument rated pilots.

A need therefore exists for improved instrumentation which provides a pilot with a simulation of the visual cues present during visual meteorological conditions regardless of the actual flight conditions.

A further need exists for a Synthetic Vision System (SVS) for not only commercial aircraft, but also for general aviation cockpits.

### SUMMARY

The following presents a simplified summary of apparatus, systems and methods associated with a multi-view head-up synthetic vision display system to facilitate providing a basic understanding of these items. This summary is not an extensive overview and is not intended to identify key or critical elements of the methods, systems, apparatus or to delineate the scope of these items. This summary provides a conceptual introduction in a simplified form as a prelude to the more detailed description that is presented later.

According to a first aspect of the present invention, a system for increasing pilot situational awareness is disclosed. The system includes a navigational component that determines one or more of an aircraft location and attitude. The system also includes a scene generator that produces one or more virtual images of the space into which the aircraft is flying based, at least in part, on the aircraft location and/or attitude. The system further includes one or more head up displays that display the one or more virtual images to facilitate increasing pilot situational awareness.

According to a second aspect of the present invention, a method for mitigating problems associated with spatial disorientation is disclosed. The method includes computing an aircraft location and attitude. The method also includes computing a displayable image of the space into which the aircraft is flying based, at least in part, on the aircraft location and attitude. The method further includes displaying the image onto one or more head up displays.

According to a third aspect of the present invention, an enhanced head up display system is disclosed. The system includes a navigational unit for determining an aircraft location and an attitude unit for determining an aircraft attitude. The system also includes an image generator for generating one or more first virtual images associated with one or more over-the-nose views and one or more second virtual images associated with one or more out-the-side-window views. The first and second virtual images are generated, at least in part, based on the aircraft location and aircraft attitude. The system further includes a first head up display for displaying the one or more first virtual images, and one or more second head up displays for displaying the one or more second virtual images.

Certain illustrative example apparatus, systems and methods are described herein in connection with the following description and the annexed drawings. These examples are indicative, however, of but a few of the various ways in which the principles of the apparatus, systems and methods may be employed and thus are intended to be inclusive of equivalents. Other advantages and novel features may become apparent from the following detailed description when considered in conjunction with the drawings.

### BRIEF DESCRIPTION OF THE DRAWINGS

Comprehension of the invention is facilitated by reading the following detailed description, in conjunction with the associated drawings, in which:

FIG. 1 is a front view of a prior art aircraft instrument panel;

FIG. 2 is a perspective view of an example aircraft illustrating various flight-related vectors;

FIG. 3 illustrates two example graphs of pseudo-roll and flight path angle, respectively, over time;

FIG. 4 is a block diagram illustrating image layers of an example synthetic vision display;

FIG. 5 illustrates a comparison of an actual view of a runway and an example synthetic vision display of the actual view;

FIG. 6 is a rear facing perspective view of an example cockpit illustrating a mounted LCD projector;

FIG. 7 is a front facing perspective view of an example cockpit illustrating combiner material disposed perpendicular to a pilot's field of view;

FIG. 8 is a front facing perspective view of an example cockpit illustrating a synthetic vision display during climb out;

FIG. 9 is a front facing perspective view of an example cockpit illustrating a synthetic vision display during final approach;

FIG. 10 is a front facing perspective view of an example cockpit illustrating a synthetic vision display while banking into approach;

FIG. 11 is a front facing perspective view of an example cockpit illustrating a synthetic vision display while leveling out;

FIG. 12 is a front facing perspective view of an example cockpit illustrating a synthetic vision display after leveled out;

FIG. 13 is a front facing perspective view of an example cockpit illustrating a synthetic vision display while approaching a runway;

FIGS. 14 and 15 are a front facing perspective views of an example cockpit illustrating a naked eye view and a synthetic vision display while approaching a runway;

FIG. 16 is a front facing perspective view of an example cockpit illustrating a synthetic vision display before touchdown;

FIG. 17 is a schematic block diagram of an example head-up display system;

FIG. 18 is a schematic block diagram illustrating an architecture of an example head up display system; and

FIG. 19 is a schematic block diagram of an example inertial subsystem employed by the head up display system.

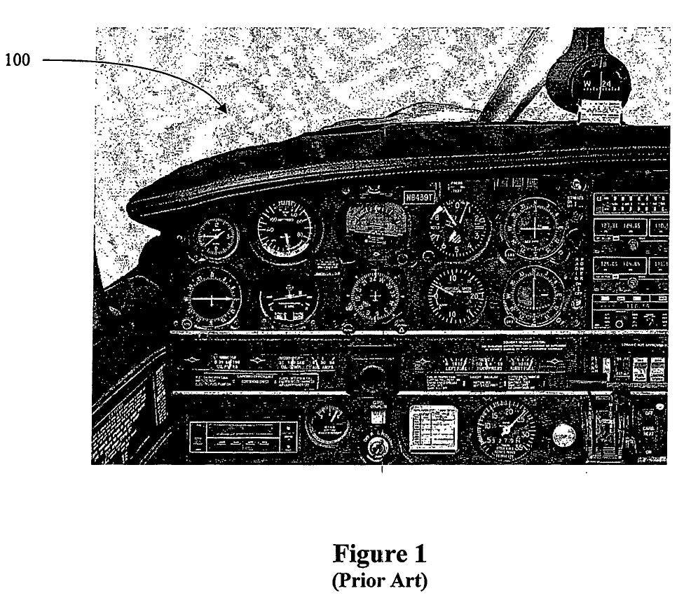

### DETAILED DESCRIPTION

According to the present application, the GA cockpit can be upgraded by combining an Attitude and Heading Reference System (AHRS), a Navigational system, such as a Global Positioning System (GPS) or Inertial Navigational system (INS), for example, and an advanced display system. Attitude information, coupled with navigation-derived position and velocity information, can be used to present the pilot with multiple “out the window” views, such as a forward view and a side view, for example, on a head-up display (HUD). Integrating the display(s) with the outside world provides the pilot with a better understanding of the aircraft altitude and/or flight path. Thus, the pilot spends less time determining the aircraft's position and orientation than is typical when flying instruments. Furthermore, the pilot employs the conventional VMC technique of looking out the window, rather than the IMC technique of looking at the instruments.

HUDs facilitate providing flight path information to the pilot. When the aircraft emerges from IMC conditions into VMC conditions, such as when the aircraft breaks out of the clouds, the pilot can transition from instrument flight to visual flight without diverting attention from the HUD since the pilot can look at and/or through the HUD and out the window(s) simultaneously. Similarly, when the aircraft enters IMC conditions from VMC conditions, such as when the aircraft enters clouds during takeoff, for example, the pilot can also transition from visual flight to instrument flight without diverting attention from the HUD.

In one example of the present invention, an eHUD has the same basic architecture as a conventional Synthetic Vision System (SVS). However, a prior art SVS is panel-mounted, not implemented in a head-up configuration, which can lead to a pilot becoming fixated on instruments. For example, a computer display screen may be mounted into the “dashboard” of an aircraft. Typically, SVS components include an aircraft attitude sensor, an aircraft position sensor, a display processor, and a display.

The attitude sensor provides the orientation of the aircraft in 3-dimensional space, while the position sensor provides the approximate position. The display processor accesses and correlates the position of the aircraft to a locally level point in a database. The terrain display and symbology is then rendered according to the attitude and position of the aircraft and sent to the display.

The eHUD is distinguishable from a conventional SVS on at least four attributes. First, the eHUD is implemented as a head-up display. Secondly, in one example, the eHUD uses a single GPS antenna and receiver to approximate the aircraft attitude from the velocity vector. Third, the eHUD provides multiple views, such as, out the front window and out the side window, for example, whereas conventional systems may only provide a restricted “over the nose” view. Fourth, the eHUD displays a “virtual flight world” as opposed to symbology associated with a flight path. For example, rather than displaying an electronic version of an artificial horizon instrument on the HUD, the eHUD displays a rendering of the horizon.

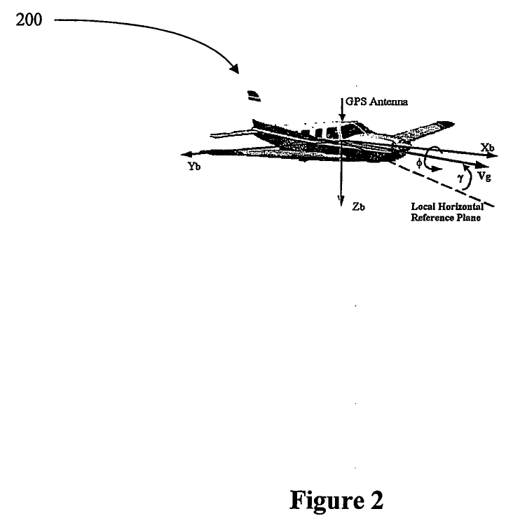

Referring now to FIG. 2, there is illustrated a perspective view of an example aircraft 200 illustrating various flight-related vectors. Single GPS antenna attitude determination does not provide the true attitude of the aircraft, which consists of the roll (φ), pitch (θ), and yaw (ψ). Instead it provides two variables, the Pseudo-Roll (φ) and the Flight Path Angle (γ), that make up the Pseudo-Attitude. The Ground Track Angle (ψ^{T}) derived from GPS-estimated position and velocity approximates yaw.

Using a simple single GPS antenna reduces one example eHUD to three components; a GPS receiver that provides aircraft attitude and position, a display processor, and the head-up display that includes the projection system. In one example that incorporates more components, both an Attitude Heading Reference System (AHRS) and a Wide Area Augmentation System (WAAS) GPS receiver can be incorporated into the eHUD to improve position, velocity, and attitude accuracy.

While the single GPS antenna does not provide the true attitude of the aircraft, the single GPS antenna attitude determination provides a close representation of the true attitude of the aircraft which facilitates installing a cost-effective SVS on an eHUD to be placed in GA aircraft. Thus, conventional SVS systems that employ additional components like forward looking infrared radar (FLIR), microwave sensors, laser sensors, and so on, can be simplified through the eHUD.

Several example eHUDs have been tested in a Piper Saratoga (PA-32-301). Certain characteristics of the Saratoga were used to determined the weight, size, and power consumption of a first generation prototype eHUD. The Piper Saratoga is a single-engine, low-wing aircraft capable of carrying six occupants FIG. 2). The Saratoga is configured with a 3-blade variable pitch/constant speed propeller that is driven by a Lycoming IO-540-K1G5 (300 Hp) engine. The aircraft has an empty weight of 2216 lbs with a useful load weight of 1384 lbs and a cruising speed of 135 knots at 65% power.

A power inverter supplied AC power to the prototype eHUD, which reduced the available power to 3.0 amps at 14.0 volts AC. The GPS receiver drew 0.23 amps and the projection system drew 1.0 amp, leaving 0.23 amps available to run the display processor. The display processor for the first generation eHUD was a 700 MHz Pentium III laptop manufactured by Dell. At maximum power consumption the Dell drew 1.5 amps. Because the combined receiver, projection system, and display processor current requirement was greater than 3.0 amps, in one example the display processor was run from its internal battery. This facilitated the first generation eHUD drawing less than 3.0 amps of current, which simplified integrating the eHUD into the typical GA cockpit where power for additional systems is limited.

The Saratoga has a great deal of cargo and passenger space, but like most general aviation aircraft it has little room in the cockpit for additional equipment. Cockpit space is precious. Establishing the prototype as an eHUD facilitated providing multiple views, namely, over the nose and out the side window, while consuming minimal cockpit space. In one example, when the eHUD is positioned in the front window, it provides an over the nose view, but when positioned on the side window, it provides an out the side window view. Thus, in one example, the eHUD provides advantages over conventional systems by being aware of its relative location in the cockpit and providing a view related to its position. In another example, separate eHUDs are employed for forward and side views. In yet another example, the eHUD can be implemented in transparency display screens (e.g., Kodak paper) obviating the need for the projector component. Of course, other means for displaying the head-up display are possible.

The windshield area on either the left or right side of the Saratoga cockpit provides an area of approximately 18 inches by 18 inches in which a piece of tinted glass could be mounted in the pilots field of view. This is roughly the size needed to correctly render the displayed image to the pilot. While this provisional application describes the eHUD in a Saratoga cockpit, it is to be appreciated that the eHUD can be employed in other cockpits and is not limited to a Saratoga cockpit.

The first generation eHUD also addressed human factors associated with the SVS refresh rates. Synthetic vision is known in aviation and certain problems, such as latency, have been addressed in SVS systems. To mitigate latency problems with pilot in-the-loop control, the eHUD display was refreshed at approximately 30 Hz. Those skilled in the art will understand that other refresh rates could also be applied. The attitude information benefits from being generated to at least 10 Hz to accurately relay the aircraft state to the pilot. In one example, the eHUD provides visual information to the pilot with a delay not greater than 100 ms for each sample of the aircraft state. In one example, the processing latency is 28 ms, which falls well within the design criteria.

The first generation eHUD synthetic vision display had a refresh rate of approximately 30 Hz. This rate was related to the intensity of the graphics being rendered to the pilot. To facilitate faster refresh rates, buildings and other unnecessary features that were not indicative of height were removed. It is to be appreciated that as computing and rendering speeds increase, that an eHUD SVS may display more detail.

A NovAtel OEM-4 3151R Power Pack was employed for the GPS to facilitate providing independent position and velocity information at 20 Hz. The OEM-4 can, in one example, employ WAAS signals. The receiver calculates user velocity directly from Doppler measurements and not from position derivatives. This provides the eHUD with the true velocity of the aircraft at a given position and allows for more accurate attitude determination from the manipulation of the velocity vector.

In one example, the display processor performs three primary functions; communicating with the GPS receiver, calculating the aircraft attitude, and rendering the correct display. While three functions are described, it is to be appreciated that a greater and/or lesser number of functions can be performed by the display processor and that one or more display processors may be employed in serial and/or substantially parallel processing. The prototype applications were written in Visual Basic and C++, although one skilled in the art will recognize that other languages, such as C, assembler and C#, for example, could be employed with the eHUD. In one example, applications called a C++ Dynamic Link Library to perform attitude, calculations.

In the first generation eHUD, a first step in the display processor communicating with the GPS receiver is the initialization process. Position and velocity strings can be requested at a rate of 20 Hz, for example. Once the GPS logs have been requested they can be sent at regular time intervals until the logs are cleared or until the unit is reset by a power off.

The NovAtel GPS receiver employed in the first generation eHUD can provide its user with several types of data strings in the form of logs. In one example, the Best Position string and Best Velocity string are requested in ASCII format. The position string is approximately 203 characters in length and the velocity string is approximately 157 characters in length, producing a data message that is 360 characters in length or 2880 bits. This message was requested 20 times per second, for a total of 57,600 bits requested each second. The data link from the receiver to the display processor was a 9-pin null modem cable standard RS-232. The data rate between the GPS receiver and the display processor was set at 115,200 bps, no parity, 8 data bits, 1 stop bit, no handshaking with the echo off. While one example GPS receiver, string request rate, string size, and communication methodology are described, it is to be appreciated that the eHUD can employ other GPS receivers, request strings, communications methodologies and so on.

In one example, the display processor monitors the communication port via interrupts. When an interrupt is received the string is parsed for the GPS time stamp, latitude, longitude, Mean Sea Level (MSL) altitude in meters, horizontal speed in meters per second, vertical speed in meters per second, and the ground track in degrees with respect to North. This information is then provided to the DLL for calculating the aircraft attitude. In other examples, the display processor may share memory with the GPS receiver and/or receive data from other navigational systems, such as inertial navigation systems, for example.

One example attitude determination algorithm was written in C++ as a class capable of calculating and tracking the aircraft attitude as well as its East and North position in meters from a locally level datum point. For one example prototype, the attitude of the aircraft was calculated using the velocity vector from the GPS receiver. To use the velocity vector to derive the attitude it is assumed that the aircraft is in coordinated flight with the velocity vector in close proximity to the x-body axis, which extends from Center of Gravity (CG) through the nose of the aircraft. The GPS antenna is placed just above the aircraft's CG, providing the velocity of the aircraft as if it were a particle traveling through free space.

While an aircraft is in a coordinated turn the lift force is acting against two forces; the gravitational acceleration and the normal acceleration multiplied by the mass of the aircraft. The lift force is perpendicular to the y-body axis but the orientation of the body frame is unknown. The normal gravitational acceleration is known and the normal acceleration of the aircraft can be derived from the velocity vector. The vector difference between the normal gravitational acceleration and the normal acceleration of the aircraft provides an approximation of the magnitude and direction for the lift vector. This approximation of the lift vector can be referenced against the local horizontal plane to determine the Pseudo-Roll (φ) of the aircraft.

The Flight Path Angle (γ) is used to approximate the pitch of the aircraft. The GPS receiver provides the horizontal speed and vertical speed of the aircraft in meters per second. The Flight Path Angle is the inverse tangent of the vertical speed divided by the magnitude of the horizontal speed.

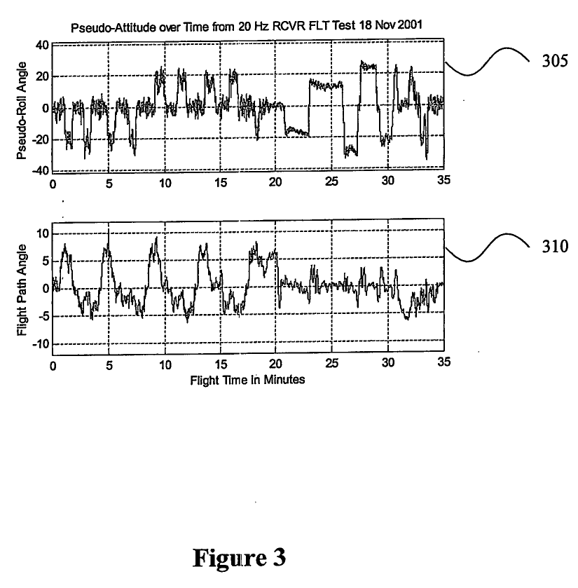

FIG. 3 shows a graphical representation of the Pseudo-Attitude. The upper plot 305 on FIG. 3 shows the Pseudo-Roll (φ) over time during a 35-minute flight test. Positive angles indicate a roll to the right, while negative angles indicate a roll to the left. The lower plot 310 on FIG. 3 shows the Flight Path Angle (γ) over time with positive angles indicating a positive flight path or climb. The derivative of the velocity vector is taken with respect to time, providing the acceleration vector of the aircraft. The acceleration vector is then projected onto the velocity vector to determine the tangential acceleration vector. The vector difference between the acceleration vector and the tangential acceleration vector is the normal acceleration vector. The normal acceleration vector and the gravitational acceleration vector multiplied by the mass of the aircraft are the forces that the lift vector is counteracting in a coordinated turn. The vector difference between the gravitational vector and the normal acceleration vector produces the lift vector. The direction of the lift vector is perpendicular to the y-body axis. Crossing the velocity vector with the gravitational vector produces a horizontal reference that facilitates determining the angle between the y-body axis and the horizontal reference. This angle is the pseudo-roll of the aircraft. It is to be appreciated that this is but one attitude determination procedure, and that other attitude determination procedures employing other navigational hardware and/or software can be employed in accordance with the eHUD.

The GPS receiver provides the horizontal speed and vertical speed of the aircraft in meters per second, for example. The Flight Path Angle is the inverse tangent of the vertical speed divided by the magnitude of the horizontal speed. Pseudo attitude may require additional processing for stall or sideslip situations since pseudo-attitude provides information that is dependant on the velocity vector being in close proximity to the x-body axis of the aircraft. If the velocity vector is not in line with the x-body axis then the aircraft attitude may require re-computing to drive an SVS display.

In one example, the display rendered to the pilot is the terrain in the direction of the velocity vector and not in the direction of aircraft heading. During steady sideslip the pilot is still being provided with the terrain information in the direct flight path of the aircraft.

For the first generation eHUD, velocity vector attitude determination meets the basic design criteria for sensing the attitude of an aircraft in coordinated flight and in the presence of steady sideslip. Pseudo-attitude also allows a cost-effective means to provide attitude for the display as well as providing an algorithm that is not computationally intensive. The combined accuracy and computational ease also reduces latency between the time when the attitude is sampled and when the display is rendered to the pilot. Thus, SVS based on velocity vector attitude determination is one example of SVS that can be employed with the eHUD.

In one example, to reduce display jitters, during large banking maneuvers, a three point moving average was placed on the pseudo roll and the flight path angle. Additionally, and/or alternatively, a Kalman filter could be used to further facilitate such display phenomena.

In one example eHUD, an off the shelf 3D graphics engine produced the graphics. The graphics engine was manipulated through Microsoft Visual Basic, which allows for the display to be packaged in an application. This application can be modified to read files or live input from a GPS receiver to run the display, for example. It is to be appreciated that a variety of graphics engines can be employed with the eHUD.

The SVS convinces the user of the aircraft state, convinces the user of the aircraft position, and provides a runway (or other navigational location) surrounded by realistic terrain features which facilitates increasing pilot situational awareness and thus reducing spatial disorientation. The aircraft attitude is provided to the display in the form of Pseudo-Attitude, consisting of the Pseudo-Roll (φ) and Flight Path Angle (γ) along with the Ground Track Angle (ψ_{T}), twenty times per second. These parameters are used to set the spatial orientation of a “camera” from which to view the outside world.

Aircraft position can be obtained, for example, from the NovAtel GPS receiver 20 times per second. The position data from the receiver is used to place the camera in the terrain at the correct height and in the correct local East and North position relative to the runway threshold. The horizontal position information is given as latitude and longitude. The display is based on a locally level coordinate system with the origin at the threshold of the runway. The latitude and longitude are converted to East and North in meters relative to the runway threshold using Vincenty's Inverse Formulae. The height information is adjusted to an Above Ground Level (AGL) height from the GPS receiver height given with respect to Mean Sea Level (MSL). As the position and attitude information are updated the camera moves about the display with the correct spatial orientation indicating the actual flight path of the aircraft. While in one example camera position can be determined using GPS data and Vincenty's Inverse Formulae, it is to be appreciated that camera position can be determined by other methods including, but not limited to, inertial navigation systems and other sensor systems.

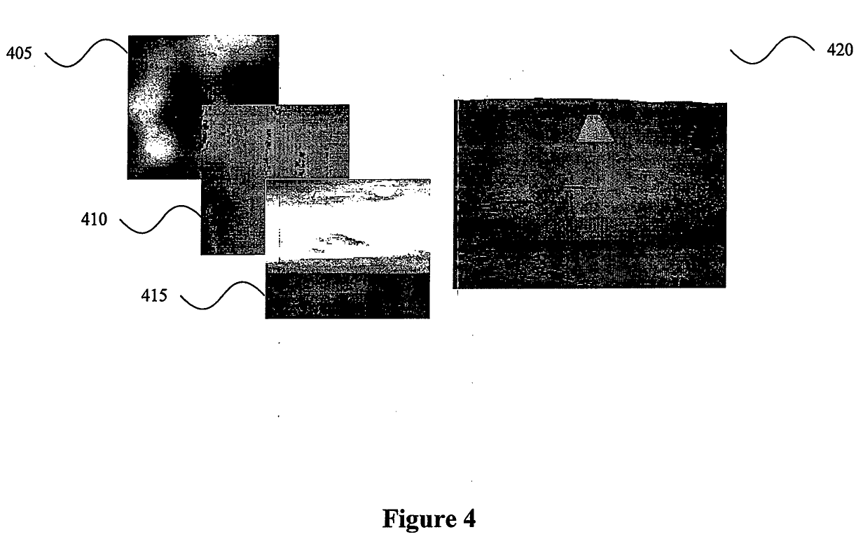

In one example, illustrated by FIG. 4, the synthetic vision produced by the graphics engine includes four fundamental images. There is a terrain map 405, which serves as a database, a texture plate, a color plate, and panoramic sky image 415. The terrain map 405 can be, for example, a gray scale bit map that indicates the height of the terrain in meters. The terrain height is set with white being the highest points in elevation and black being the lowest points of elevation. The Ohio University Airport (UNI) in Albany, Ohio, is situated on a flat level piece of ground surrounded by rolling hills. The design of the gray scale bit map is set up with the runway and the surrounding airfield as the lowest points. The height data from the receiver is then adjusted by subtracting out 231 meters, which is the runway height above MSL. When the aircraft is on the ground at the end of the runway the camera height is 1.0 meter above the runway in the display to provide the correct cockpit view. While the terrain map 405 for the prototype included information from the Ohio University Airport, it is to be appreciated that terrain maps for other airports and/or other locations can be employed with the eHUD.

The texture plate was placed on top of the terrain map 405 to produce a more three-dimensional look and feel. The basic texture plate relies on the color plate to produce convincing depth and motion perception. In one example, the color plate is limited to two colors, a basic green with uniform black pattern that provides a sense of depth and motion. The “painted” terrain map 410 is then “wrapped” with a panoramic photo representing the sky 415 to produce the eHUD display image 420. This photo 415 is divided into an upper and lower half providing a horizon line that gives the pilot a better sense of attitude.

Although not shown in FIG. 4, the eHUD display could include parts of the aircraft, such as the nose or wing, for example, to provide the pilot with a visual reference as to how the aircraft is aligned with the synthesized objects. Further, one of the eHUD displays could provide a “bird's eye” or “top-down” display to allow for better situational awareness, similar to a moving map display.

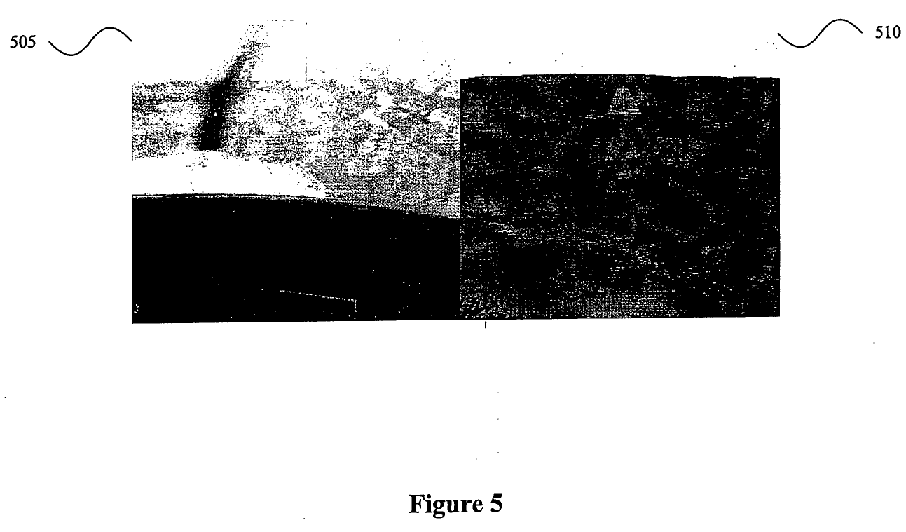

FIG. 5 shows an example eHUD synthetic vision compared to a photo taken during an approach on UNI runway 25.

In conventional HUD systems, the symbology or images displayed on the HUD are collimated (e.g., focused at infinity). In one example, eHUD, the image is not collimated, and thus is focused on the eHUD display (e.g., 18 inches from pilot's eyes). While flying in instrument conditions, the pilot typically can not see to infinity, and thus focusing the eHUD display on the display screen does not generate changing depth of focus problems. When the pilot emerges from instrument conditions to visual conditions, the pilot will likely notice, such as through peripheral vision, that conditions have changed and thus the pilot will transition to focusing outside the aircraft by looking out the window. In conventional head down display SVS systems, the pilot may not notice the change from instrument to visual conditions and thus may never divert their attention from the dashboard display and thus may never look out the window, losing the potential advantages of the availability of visual flight feedback.

Current head-up displays use symbology to provide information regarding the attitude and altitude of the aircraft to the pilot. In the eHUD, since a virtual world is being provided to the pilot and not just symbology, the perspective of the projected display is highly dependent on the physical make-up of the pilot. When a pilot's vision is obscured by poor weather, a panel-mounted SVS display provides a forward-looking picture of the outside world relative to the aircraft's CG. When this same virtual view is provided through a head-up display, the perspective that needs to be rendered in order for the real world and virtual world to overlap depends on the view of the pilot observing the display. If a pilot is short in stature, then the perspective is different than that of a pilot whose head is against the ceiling of the aircraft. For this reason, in one example, a dynamic method of “tuning” the perspective is incorporated into the eHUD. Once the pilot is seated in a normal position then the display can be moved up, down, left, or right until the virtual world and the real world coincide. In another example, a flight engineer or the pilot manually tunes the eHUD for the pilot.

The eHUD is new to GA aircraft because it provides one or more “out the window” views for the pilot. Conventional synthetic displays are implemented as a head-down display where the pilot diverts attention from the window view to the panel-mounted display. Thus, the pilot risks becoming “instrument fixated”. The eHUD allows the pilot to keep attention on the task at hand by placing the synthetic vision in their direct field of view.

In one example prototype, the “over the nose” eHUD display was implemented using a LCD projector and a piece of “combiner material” with a rubber coating guarding the edges. The LCD projector was a Digital Multimedia Projector PG-M10X manufactured by Sharp. The Sharp projector is a compact and lightweight projector measuring 2.5″×6.5″×9.0″ and weighing approximately 3 pounds. It has a low power consumption requiring only 1.0 amp from the 3.0 amps available on the aircraft, making it suitable for add-on electronics in the GA cockpit. While one example projector and combiner material are described, it is to be appreciated that other display producing systems can be employed with the eHUD. For example, another display was implemented using an InFocus Digital Multimedia Projector LP280. This alternate projector was chosen for its size, keystone correction capability, range of inputs, and its front or rear projection capability.

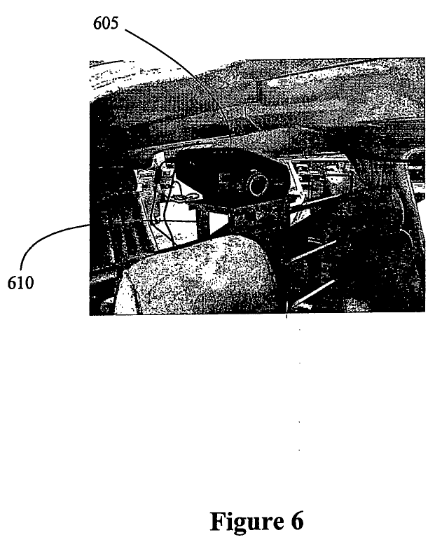

Referring now to FIG. 6, there is illustrated a rear view of a Saratoga cockpit. As shown, an example LCD projector 605 may be mounted to face the front of the cockpit via a mounting means 610. Although the mounting means is illustrated as a support structure dispose below projector 605, alternate mounting arrangements will be recognized by those skilled in the art.

The forward facing projector of the first generation eHUD, providing the forward “over the nose” view, was mounted to the ceiling of the aircraft between the pilot and safety pilot. It was set back about 3 inches from the front side of the pilot seat headrest at a slight angle to project the synthetic image of the terrain onto the tinted glass in the pilot's field of view. Concerning the mounted projector, keystone correction is used to remove any nonsymmetrical properties of the projected image. The “camera” can be employed to provide over the nose views and/or out the side window views.

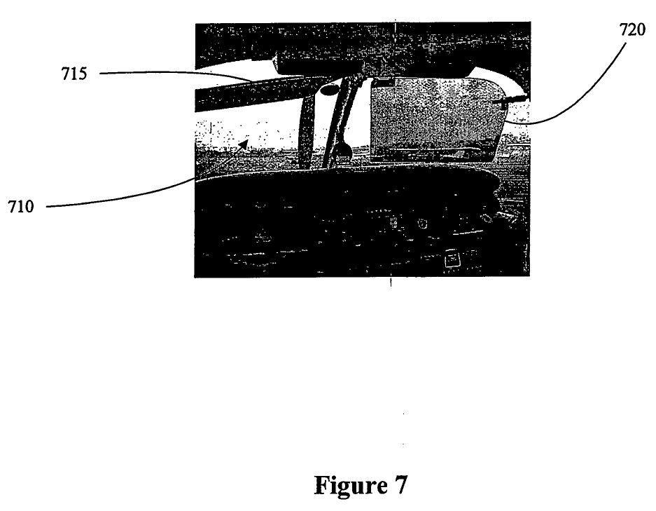

Referring to FIG. 7, there is illustrated a forward view of the Saratoga cockpit, equipped with two transparent image combiners 715 and 720 disposed between the pilot and the windshield 710.

The combiner material can be a variety of materials. In one example, the combiner material was a 14″ by 10″ sheet of ¼″ Lexan 9034. In another example, the combiner material was a piece of tinted glass about 18″ by 18″ with a thick rubber coating on the edges. In another example, it was a sheet of shatterproof Plexiglas. The combiner material was placed directly in the field of view perpendicular to the pilot's line of sight. The combiner material was mounted to a hinged brace that positions the display against the dash to allow for maximum pilot movement and minimal effect on regress issues. In one example, lowering the combiner material is a manual task performed by the pilot when the display is needed. In another example, the combiner material can be raised/lowered/repositioned automatically by the eHUD system to facilitate providing a relevant (e.g. over the nose, out the side window) view. When the display is not needed, the combiner material can be stowed above the pilot's head out of the field of view. In one example, the projection device is turned on and off by the raising and lowering of the display. In another example, the projection device can be turned on/off by other methods including, but not limited to, automatic determination of flight conditions, voice command, control stick command, dashboard switch, and so on.

The Enhanced Head-Up Display (eHUD) was designed for the low-time instrument rated pilot, to facilitate enhancing situational awareness in IMC at relatively low cost. While early eHUDs were initially envisioned to support only the landing phase of flight, subsequent eHUDS have facilitated enhancing situational awareness in all three phases of flight, departure, en-route flight, and landing.

Although not illustrated in FIG. 7, the system can include either or both left and right side displays. Other views can also be incorporated including, but not limited to, bird's-eye, eccentric and profile views. It is also possible that the multiple displays could be helmet-mounted so as not to interfere with existing equipment in the aircraft. In some embodiments, is may be useful to mount the displays in a variety of locations in the aircraft including, but not limited to, having all of them in the standard instrument panel.

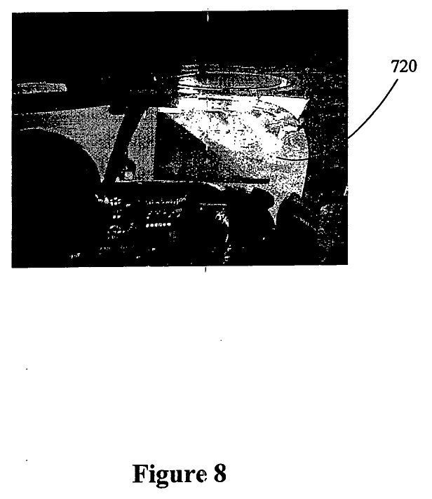

FIG. 8 shows the eHUD during climb out as the aircraft was banking left into the down wind leg of the traffic pattern.

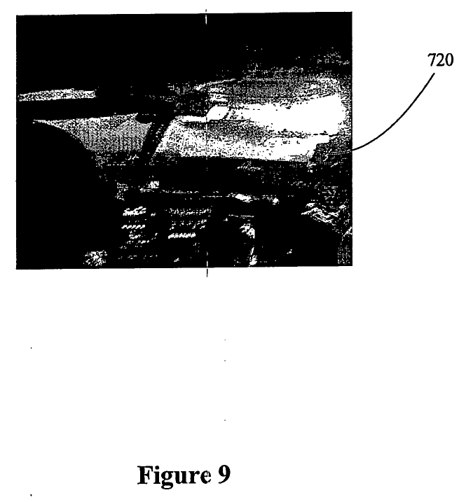

FIG. 9 shows an example eHUD during a final approach. The virtual horizon matches that of the real horizon indicating that the pitch and roll of the aircraft were being provided to the pilot accurately and in real-time.

The landing of an aircraft in IMC is a time when a technology like the eHUD can provide the pilot with significant benefits. The eHUD is an aid that helps the pilot safely navigate the aircraft to a decision height (e.g., 200 feet AGL) where the pilot will either be able to land the aircraft visually or perform a missed approach because the runway could not be identified. In the latter of the two cases, the pilot would not even have attempted to land the aircraft, and would have diverted to another airport.

An illustration of an application of the eHUD is an Instrument Flight Rules (IFR) scenario where visibility might be three to four statute miles, but the ceiling is only 800 feet. In this scenario the ceiling is composed of cumulus clouds producing moderate turbulence effectively increasing the single pilot workload. The pilot would perform a standard instrument approach crossing the seven-mile beacon perpendicular to the runway, banking right and eventually coming about so the aircraft is lined up on the runway. The aircraft should be at a height of approximately 2230 feet AGL and seven nautical miles from the runway threshold. At this time the aircraft is still well within the clouds and the pilot is flying “blind”.

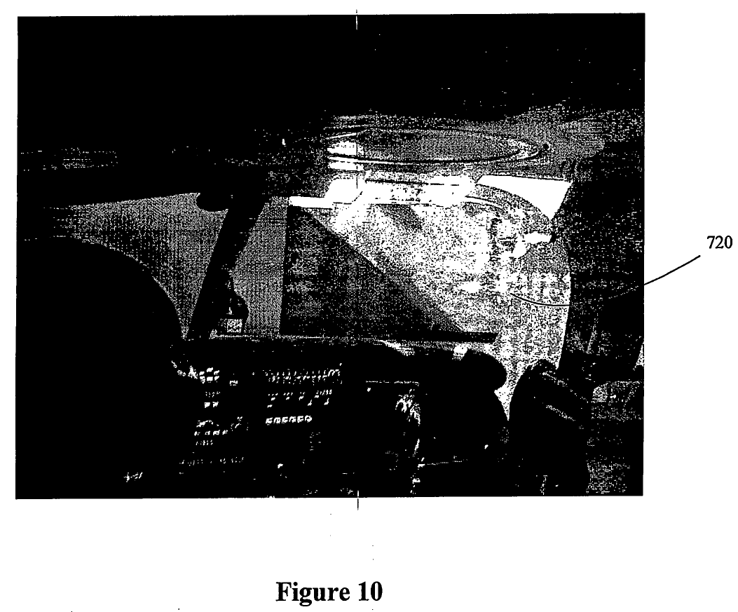

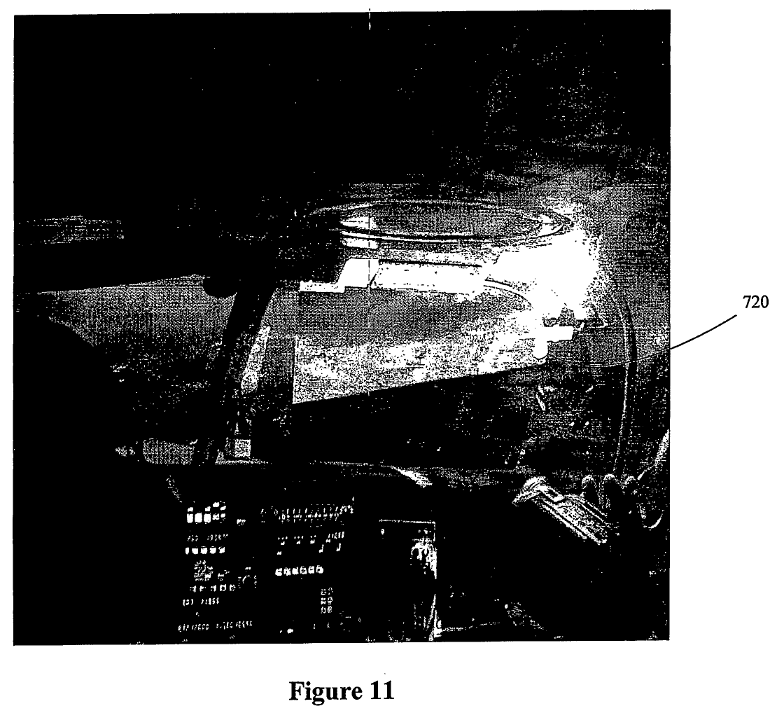

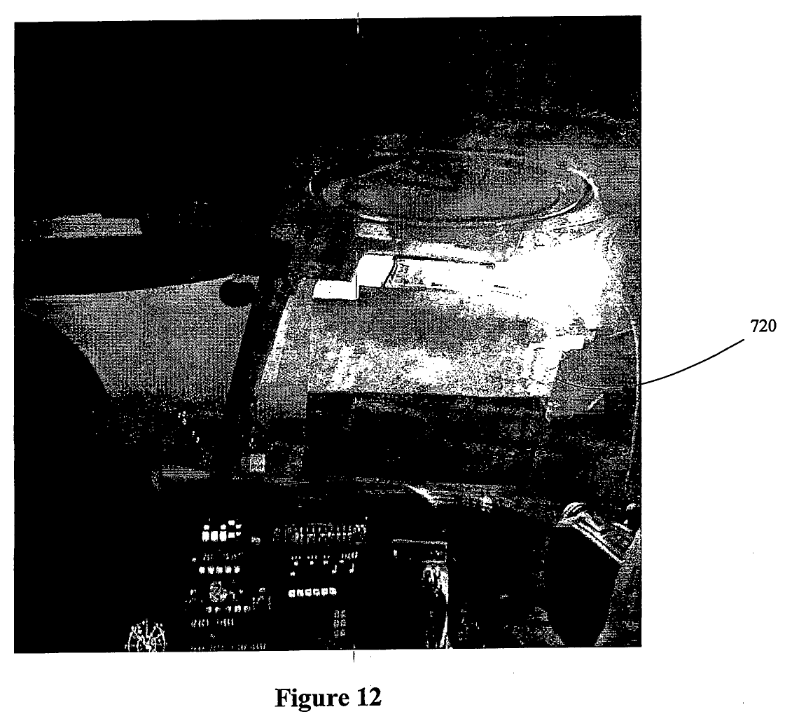

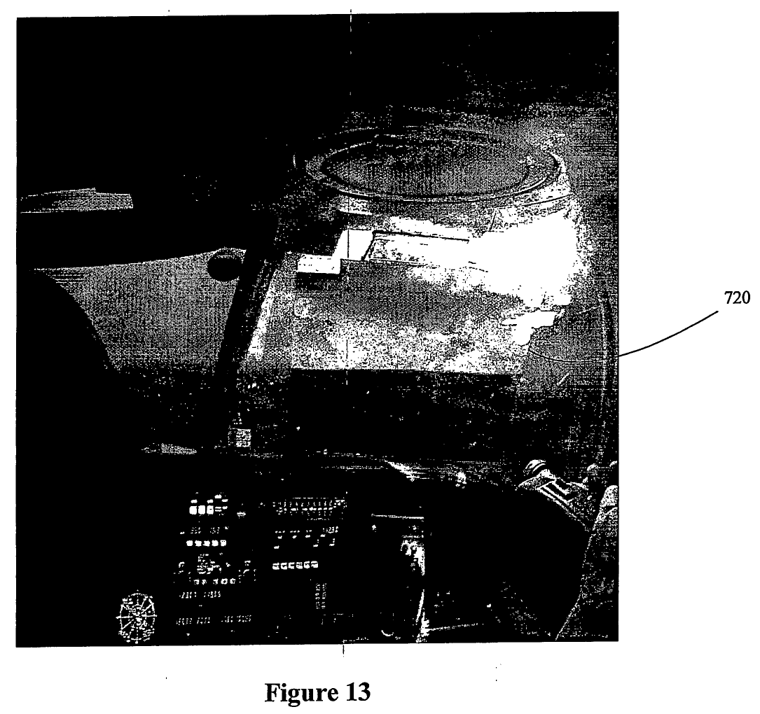

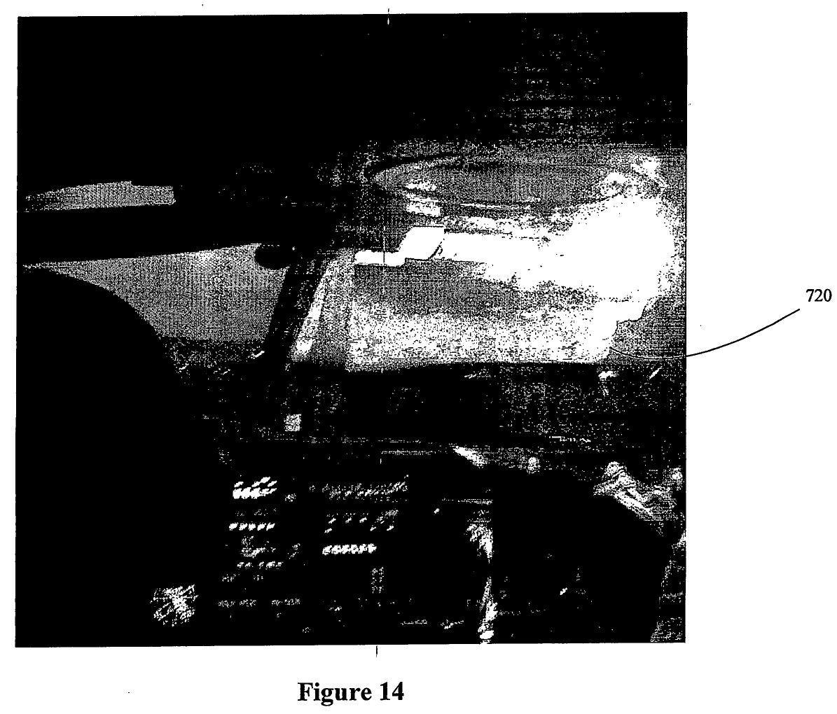

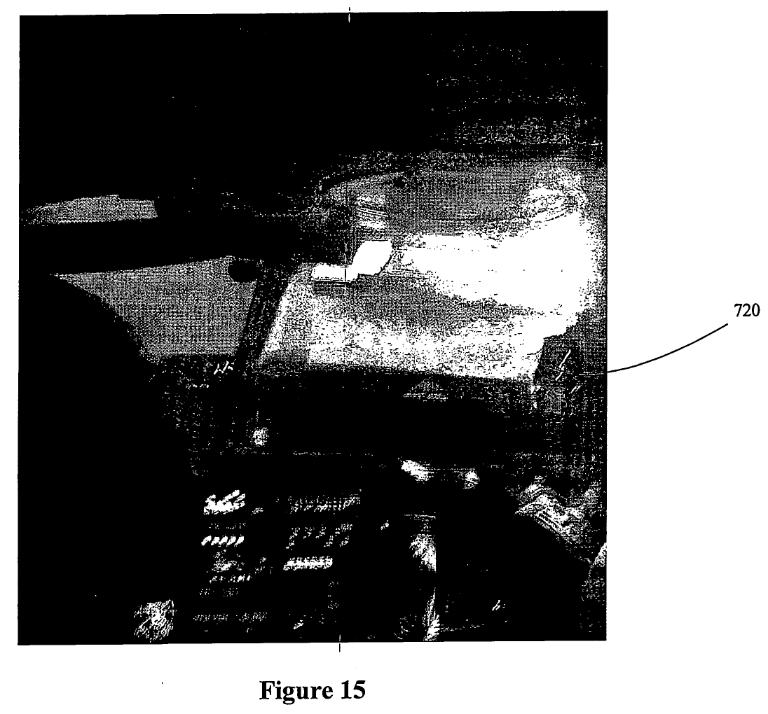

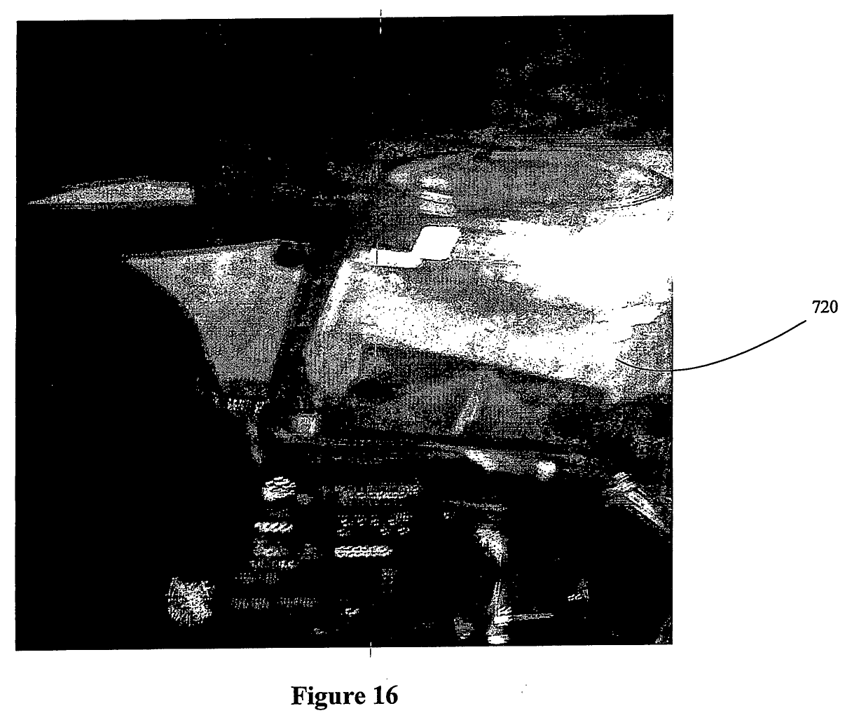

A series of eHUD displays representing various stages of aircraft runway approach and landing are illustrated in FIGS. 10-16. FIG. 10 illustrates an eHUD display when banking into an approach. FIG. 11 illustrates an eHUD display when leveling out. FIG. 12 illustrates an eHUD display after leveling out as the runway begins to come into view. FIG. 13 illustrates an eHUD display during continued approach to the runway. FIG. 14 illustrates an eHUD display upon further continuing approach to the runway. The naked eye view of the runway can is visible through windshield 710. FIG. 15 illustrates an eHUD display upon further continuing approach to the runway. Again, the naked eye view of the runway can is visible through windshield 710. FIG. 16 illustrates an eHUD display just before touchdown on the runway.

Conventionally, the only choice the pilot has is the ILS and watching the “T” on the instrument panel of the aircraft. With the eHUD installed in the aircraft, the pilot would engage the eHUD, whereupon the eHUD would initialize the display to the correct position, altitude, and attitude. Within seconds the pilot could be looking at the runway with the synthetic vision provided by the eHUD, rather than struggling with IFR conditions. The pilot then uses the synthetic vision as an aid to navigate the aircraft on a glide slope of 3° to within about a nautical mile from the runway threshold. The aircraft would be at a height 300 feet AGL, which is below the clouds, allowing visual flight. Thus, the pilot could disengage the eHUD and land visually. The eHUD places the synthetic vision in the pilot's direct field of view which overlaps the visual world with the real world. Thus, the pilot can determine when the plane breaks through the clouds into visual conditions, permitting the pilot to fly visually from that point on. This is an advantage over a head-down panel-mounted display, which is troubled by some of the same distractions as flying a standard instrument approach using the “T” on the instrument panel.

Another example scenario in which the eHUD could provide the pilot with assistance is during instrument climb-out. During VMC the pilot monitors the view from the front windshield and occasionally checks the aircraft's position and attitude out the side window. During IMC, the pilot no longer is in visual flight and must rely on the instrument panel. For an aircraft equipped with the eHUD, instrument climb-out would be much safer due to the fact the pilot would have the visual cues afforded under clear conditions.

If the scenario is examined during a climb-out, with a ceiling of 800 feet AGL, and visibility between 3 and 4 statute miles, the preflight check list would be modified only slightly. Before take off the pilot would initialize the eHUD and then run through the normal preflight checklist. The pilot could then fly visually until reaching the cloud ceiling. Once the pilot climbs into the clouds the eHUD can be engaged to facilitate providing visual cues needed to maintain attitude.

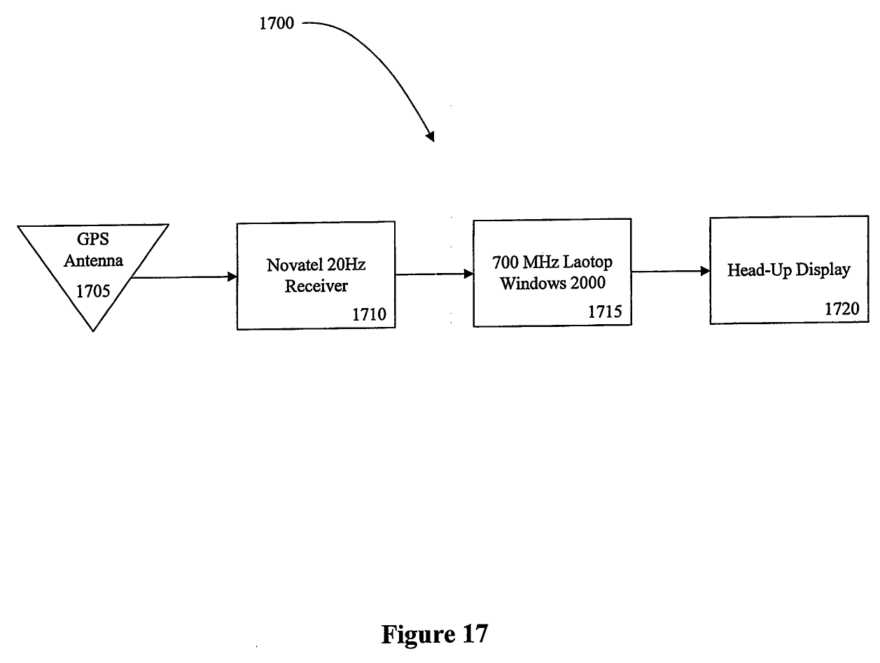

One example eHUD configuration is illustrated in FIG. 17. As shown, the example configuration employs a single GPS antenna 1705 which provides GPS data through a receiver 1710 to a compute 1715 equipped to process the GPS data and provide a synthetic vision display. The synthetic vision display is rendered by head-up display device 1720.

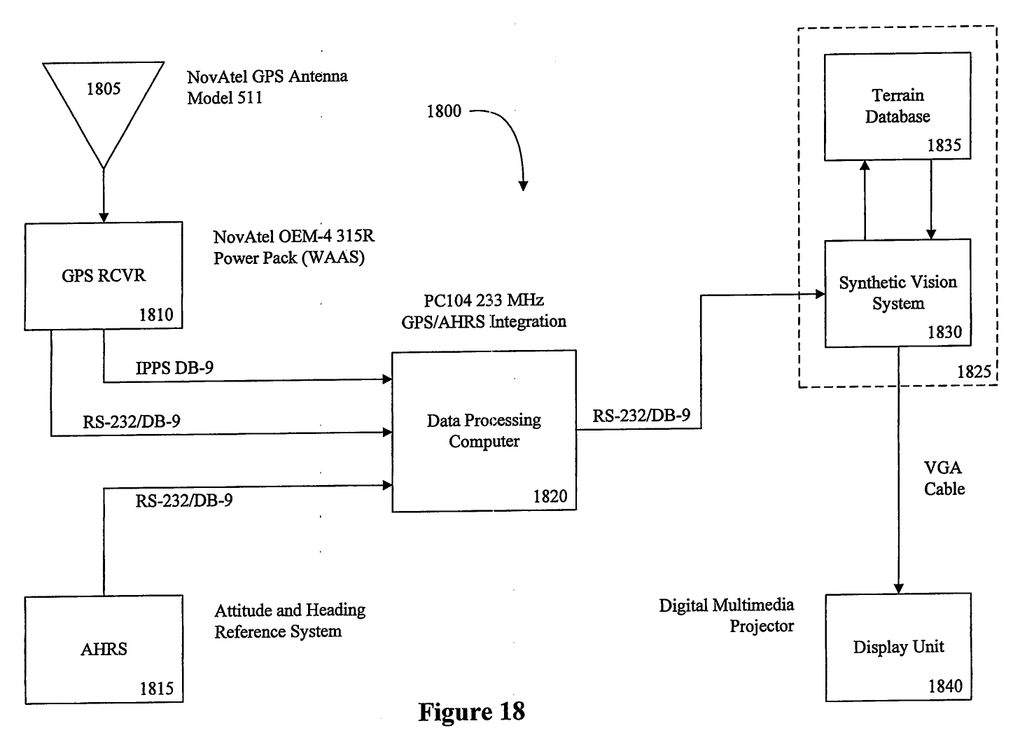

Several configurations are contemplated for an eHUD system. In one example system 1800, illustrated in FIG. 18, a separate computer 1820 acts as a central hub to collect data from several sensory devices (1805, 1810 and 1815) and then to send data packets to a display computer 1825, including an SVS 1830 and terrain database 1835. The Display computer 1825 provides a signal to display unit 1840 which renders the synthetic vision display for the pilot.

In embodiment of the eHUD of FIG. 18, an OEM-4 3151R GPS receiver is used to provide position and velocity information. Additionally, the receiver's firmware receives differential corrections from the WAAS. Additionally, an AHRS is used to determine the aircraft's spatial orientation. The measurements from the GPS receiver and the AHRS are fed into a central hub that will parse and analyze the data. The central hub includes a PC104 or similar dedicated computer running a real time operating system (e.g., QNX). After the data has been processed and filtered by the central hub, sensor specific packets are constructed and sent to the display device. While this example includes several components arranged in a specific configuration, it is to be appreciated that various other electrical, electronic, and computer components can be employed in association with the eHUD.

Precise attitude determination is not usually performed in general aviation aircraft due to the cost of attitude determination sensors. This is rapidly changing with the introduction of MEMS devices that are capable of providing precise, real-time attitude information. This attitude information, coupled with GPS derived position information, is capable of driving a low-cost Synthetic Vision display.

One example eHUD system includes software that was developed with the camera view located at the aircraft's center of gravity. This perspective works well if the display is mounted at the center of the instrument panel. The panel-mounted display provides a forward-looking picture of the outside world relative to the aircraft's center of gravity. When the same virtual world is provided through a head-up display, the perspective that needs to be rendered in order for the real world and virtual world to overlap depends on the view of the pilot observing the display.

Once the display is placed in the pilot's direct field of view, discrepancies in object placement or size becomes distracting. To complicate matters, the perspective is dependent on the physiological make-up of the pilot. Thus, an example display adapts to the pilot that is observing the display through the use of a dynamic perspective. This dynamic perspective can be implemented, for example, by tracking the position of the user's head with sensors.

In one example eHUD, an Attitude and Heading Reference System (AHRS) provides roll, pitch, and yaw measurements to the eHUD. Crossbow® produces an AHRS400CC™ with two model variations. The AHRS400CC-100™ is designed for high accuracy measurements under low flight dynamics with gyroscopes capable of ±100°/sec and accelerometers capable of ±2 G. The AHRS400CC-100 is a strap-down inertial subsystem that provides attitude and heading measurements, which are stabilized by Kalman Filter algorithms. Due to the implementation of the Kalman filter the unit is capable of continuous on-line gyro bias calibration. The AHRS compact size is due to its use of Microelectromechanical Systems that make the unit dimensions 3.0 in×3.75 in×4.1 in. The unit has a 60 Hz update rate with a start-up time of less than 1.0 seconds and is fully stabilized in less than one minute. The unit has low power requirements drawing only 275 milliamps and a wide input voltage range from 9 to 30 volts DC. These properties make the unit suitable for airborne operations in a general aviation aircraft and facilitate a variety of eHUD component architectures.

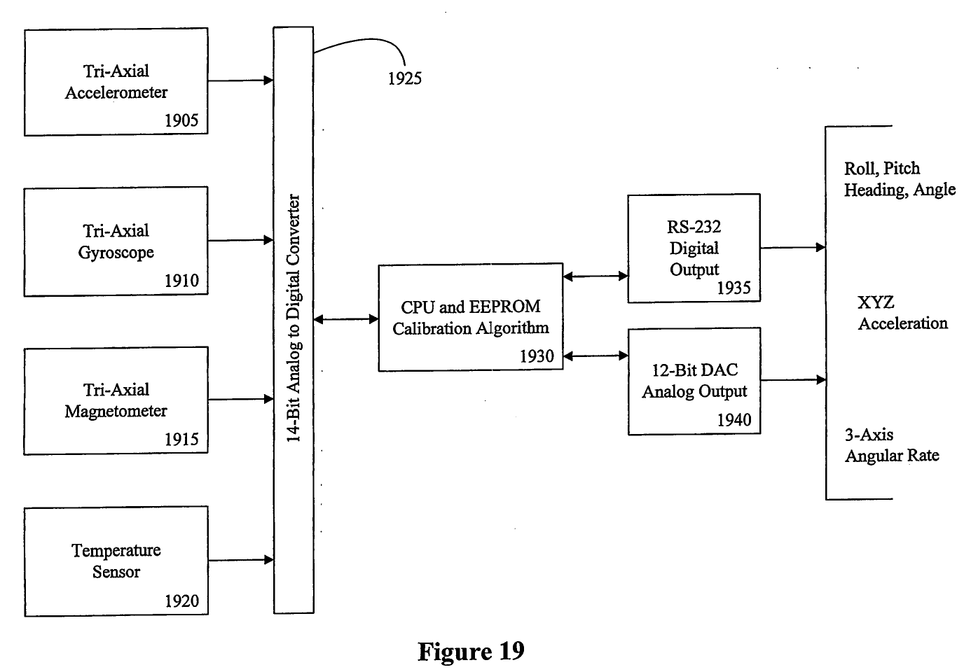

In one example eHUD system, The AHRS400CC-100™ is incorporated as the sensor for providing roll (φ), pitch (θ), and yaw (ψ) to the display. The AHRS sends its information directly to a central HUB computer that will parse the data packets for the roll (φ), pitch (θ), and yaw (ψ) angles and then send this data set to the display processor in a concise packet format. The central computer also processes information from the NovAtel® GPS receiver and incorporates pertinent position and velocity information into a separate packet employed by the display processor. This architecture, illustrated in FIG. 19, contains the AHRS and, in one example, can also contain a WAAS compatible GPS receiver. The NovAtel® unit is capable of being upgraded to receive differential corrections.

What is claimed is:

1. A system for increasing pilot situational awareness, comprising:
a navigational component that determines one or more of an aircraft location and attitude;
a scene generator that produces one or more virtual images of the space into which the aircraft is flying based, at least in part, on the aircraft location and/or attitude; and
one or more head up displays that display the one or more virtual images to facilitate increasing pilot situational awareness.

2. A method for mitigating problems associated with spatial disorientation, comprising:
computing an aircraft location and attitude;
computing a displayable image of the space into which the aircraft is flying based, at least in part, on the aircraft location and attitude; and
displaying the image onto one or more head up displays.

3. An enhanced head up display, comprising:
a navigational unit for determining an aircraft location;
an attitude unit for determining an aircraft attitude;
an image generator for generating one or more first virtual images associated with one or more over-the-nose views and one or more second virtual images associated with one or more out-the-side-window views, where the first and second virtual images are generated, at least in part, based on the aircraft location and aircraft attitude;
a first head up display for displaying the one or more first virtual images; and
one or more second head up displays for displaying the one or more second virtual images.
